(19) United States
(12) Patent Application Publication
(10) Pub. No.: US 2008/0186165 A1
(43) Pub. Date: Aug. 7, 2008

(54) System and method for monitoring the location of a tracking device

(76) Inventors: Patrick E. Bertagna, Los Angeles, CA (US); R. Eric Stalnaker, Thousand Oaks, CA (US); David S. Ryan, Glendora, CA (US)

Correspondence Address: HENNEMAN & ASSOCIATES, PLC, 714 W. MICHIGAN AVENUE, THREE RIVERS, MI, 49093, US

(21) Appl. No.: 12/012,088

(22) Filed: Jan. 31, 2008

Related U.S. Application Data
(60) Provisional application No. 60/898,902, filed on Feb. 1, 2007.

(51) Int. Cl. G08B 1/08

(52) U.S. Cl. 340/539.13; 340/670

(57) ABSTRACT

A system and method for monitoring the location of a tracking device are disclosed. An example method includes defining location criteria, associating the location criteria with a user, associating the tracking device with the user, comparing location data generated by the tracking device to the location criteria, and transmitting notification to said user if the location data satisfies the location criteria. An example system includes a tracking device interface for communicating with a tracking device, a network interface for communicating with a user, a processing unit for processing data and code, and memory for storing the data and the code, the data and the code together including data associating the tracking device with the user, location criteria associated with the user, and a monitoring routine operative to transmit notification to the user if location data generated by the tracking device satisfies the location criteria. A graphical user interface and implementing data structures are also disclosed.

### RELATED APPLICATIONS

This application claims the benefit of copending U.S. provisional Patent Application No. 60/898,902, filed Feb. 1, 2007 by the same inventors, which is incorporated herein by reference in its entirety.

### BACKGROUND

1. Technical Field

This invention relates generally to a system and method for processing tracking data, and more specifically to a system and method for enabling a user to determine criteria for tracking and notifying a user.

2. Background Art

Currently, systems exist for tracking the location of persons and/or property. Generally, such systems include a tracking device that transmits the location of the tracking device a central station, which may then take some action based on the location data.

Known systems have generally been developed as “enterprise systems.” For example, custom systems designed for a business enterprise to track assets. Such systems were not designed for, nor are they well suited for, providing tracking services to individual consumers.

What is needed is a system and method for providing personalized tracking services to consumers. What is also needed is a system and method that facilitates user defined criteria for monitoring tracking data. What is also needed is a system and method that facilitates user defined criteria for providing alerts when certain tracking conditions are met and/or violated. What is also needed is a system and method for dynamically defining criteria for monitoring tracking data. What is also needed is a system and method for dynamically defining criteria for monitoring tracking data based on data retrieved from outside data sources.

### SUMMARY

A “Geofence” is an indication of a predetermined location, for example an electronic perimeter zone setting. In one embodiment, the geofence offers at least 2 types of zone settings; a “green zone” (safe) and a “red zone” (unsafe). A personal tracking device for use with this system will be colocated (e.g., worn, carried, etc.) with the subject to be tracked. The personal tracking device and/or a remote server can store multiple zones of each type. For example, a green zone may be defined around the subject's home, school, and a nearby park, while a red zone may be placed around a prison, reservoir, or any other forbidden or dangerous location. If the tracking device breaches the zones an alert (e.g., via text message, automated call, etc.) to a phone, e-mail address, or any other predetermined destination is sent. Zone breaching occurs if the tracking device either enters a zone or leaves a zone. For example, if a tracked subject were forbidden from entering an establishment serving alcohol, a red zone could be setup around the perimeter of all bars within a given locale, and an alert could be sent to those subscribers tracking the subject if the subject entered any of these red zones. As another example, if a subject (e.g., a child) is supposed to be in school during a given time period, a green zone could be setup around the perimeter of the school and an alert could be sent to those subscribers tracking the subject if and when the subject exited the green zone.

The inventors envision many uses for a tracking system utilizing a multiple zone geofence. By way of example, the inventors envision at least the following features:

1) Velocity or geography based alerts;

2) Red zone (unsafe) or green zone (safe) zone settings;

3) The ability to store multiple zone settings of both types;

4) The ability to pre-set the zones and name them; and

5) The ability to use outside data (e.g., data from external databases, public services, vendors, etc.) to automatically update or create new zones.

The following examples are provided without limitation to illustrate certain capabilities of the system. For example, an alert could be sent and/or and event recorded if a subject is moving faster than 45 MPH or has not moved in 15 minutes. As another example, an alert can be sent and/or and event recorded if a geographical zone is breached. Named zones can be stored by or sent to those subscribers tracking the subject in the form “Red Zone—Moe's Tavern” or “Green Zone—Soccer Field”. Additionally, velocity based zones and alerts may be sent in the form “Red Zone—Subject is moving faster than 45 MPH” or “Red Zone—Subject has not moved in 15 minutes”. Once set and named, until deleted, they can be selectively activated or deactivated with one push of a button. The alert notifications may also be set up to be sent to multiple locations for multiple members tracking a subject. For example, an alert may be sent to the e-mail and/or cell phone as a text message.

The inventors envision a platform that will support defining both velocity and geography based geofences. For velocity-based geofences, alarming can be based on the device exceeding a set velocity limit, or remaining stationary for a set period of time. Such a feature would be particularly useful in tracking movement by and/or in a vehicle, or tracking the stops of a subject. Geography-based geofences can define a circular or polygon region, and notification from the tracking device to server is triggered when the device transitions across the boundary between the inside and outside of the region. In this embodiment, the geofence definitions are stored and breaches are monitored in the tracking device. Alternatively, the geofence definitions can be stored and monitored for breach on the server or jointly by the tracking device and the server. Inclusion notification occurs when the device transitions from being inside a defined region to outside the defined region (i.e., the region is “included” or allowed). Exclusion notification occurs when the device transitions from being outside a region to inside the region (i.e., the region is “excluded” or not allowed). The system can be configured to send and or record only one type or both types of notifications for each defined geographic geofence. “Red zone” geographic geofences are implemented to alarm the subscriber when the device transitions from outside to inside a geofence region. “Green zone” geographic geofences are implemented to alarm the subscriber when the device transitions from inside to outside a geofence region.

Alarm generation can be sent in multiple forms, including but not limited to email, SMS, as well as techniques to update the web display if the subscriber is viewing the site when the transition occurs. For example, a subscriber could choose which alert types they'd like to receive, as well as having the ability to view a web site showing the position and status of the subject.

Dynamic geofence generation allows the system to build real-time, instantaneous geofences to support rule-based applications as described below: For example, one application creates dynamic exclusion geofences around registered pedophiles, sex offenders, drug houses, etc. in the device's vicinity, and sets up contextually appropriate alarm messages if the device transitions into one of the dynamic geofence boundaries. Indeed, it is foreseeable that through monitoring of key databases, geofences could be setup automatically around the homes, workplaces, or even the individual pedophiles if they are tracked.

As another example, an application can define a geofence and/or trigger an alarm when the tracking device approaches businesses with set SIC codes, such as adult bookstores, strip clubs, liquor stores, etc.

A “rendezvous” application creates dynamic exclusion geofences of devices that are both in the subscriber's vicinity and on the subscriber's “friend list” (these are devices registered to other primary accounts, both which have been published to and subscribed by the subscriber and are allowed to see location). When the device nears another device on the “friend list”, both subscribers are notified of the other's proximity, including calculated distance and reverse geocode address.

### BRIEF DESCRIPTION OF THE DRAWINGS

The present invention is described with reference to the following drawings, wherein like reference numbers denote substantially similar elements:

FIG. 1 is a block diagram of a tracking system;

FIG. 1A shows an example data structure of the subscriber profile database of FIG. 1;

FIG. 2 is a block diagram of a server of the tracking system of FIG. 1;

FIG. 3 is a block diagram of a subscriber system of the tracking system of FIG. 1;

FIG. 4 is a block diagram of a tracking device of the tracking system of FIG. 1;

FIG. 5 is a screen shot of a main screen of a graphical user interface (GUI) of the subscriber system of FIG. 3;

FIG. 6 is a screen shot of a red zone selection in the GUI;

FIG. 7 is a screen shot of a green zone selection in the GUI;

FIG. 8 is a screen shot of both a red and a green zone selection in the GUI;

FIG. 9 is a screen shot of a geofence creation screen in the GUI;

FIG. 10 is a screen shot of a center point creation screen in the GUI;

FIG. 11 is a screen shot of a zone creation screen in the GUI;

FIG. 12 is a screen shot of a zone perimeter creation screen in the GUI;

FIG. 13 is a screen shot of a zone naming screen in the GUI;

FIG. 14 is a screen shot of a zone creation acknowledgment screen in the GUI; and

FIG. 15 is a flowchart summarizing an example method for monitoring the location of a tracking device.

### DETAILED DESCRIPTION

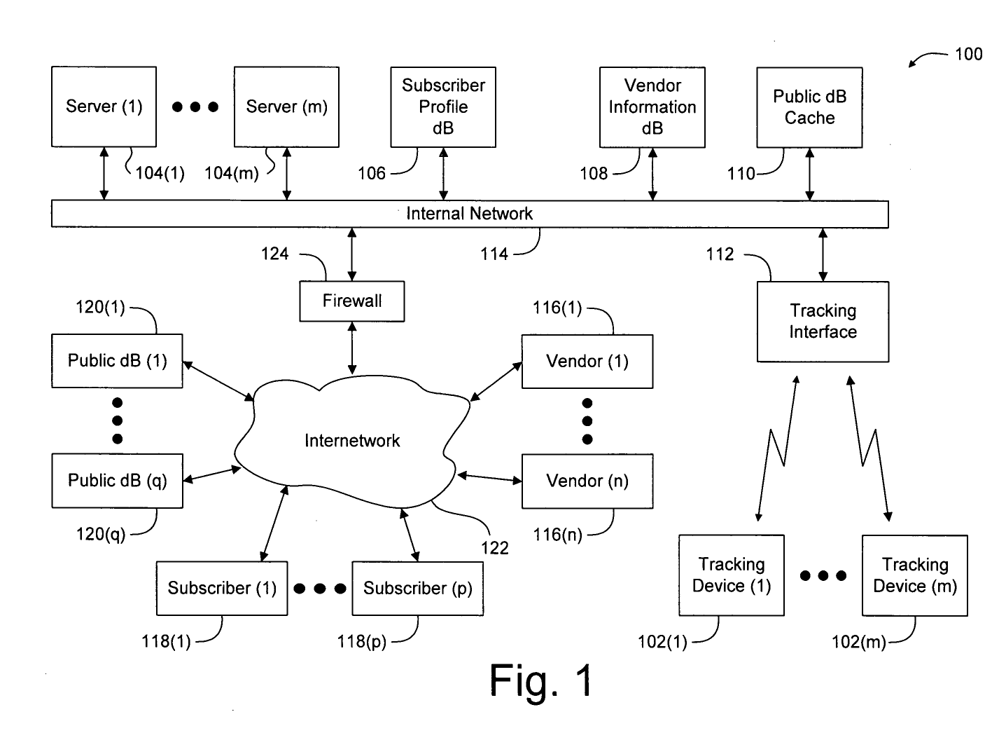

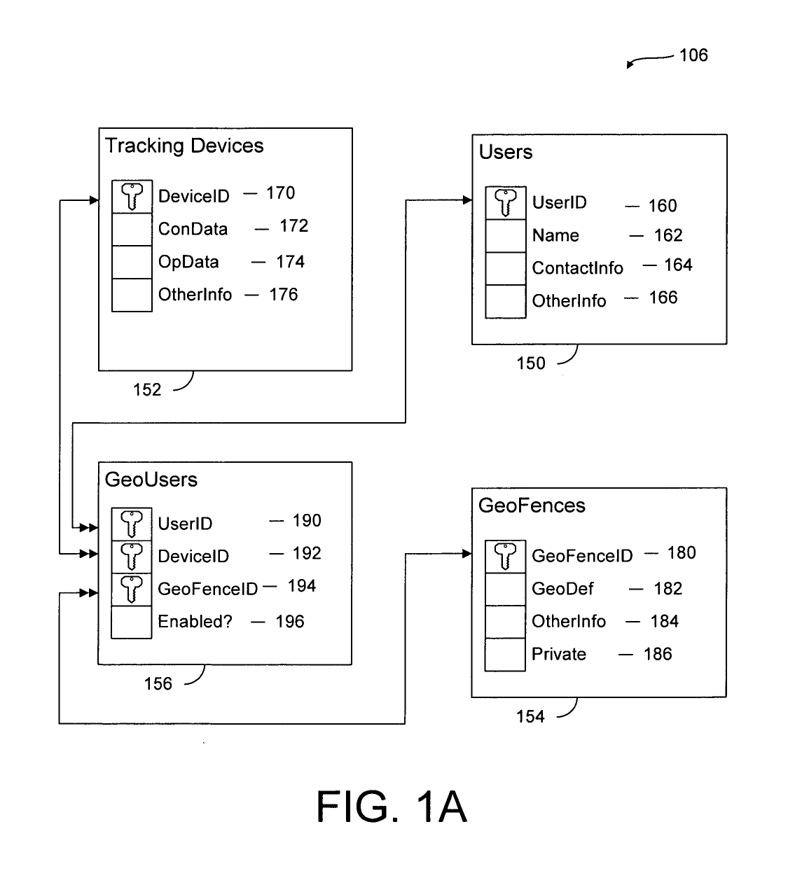

FIG. 1 is a block diagram of a system 100 for tracking and/or monitoring one or more tracking devices 102(1-m). System 100 includes one or more servers 104(1-m), a subscriber profile database 106, a vendor information database 108, a public database cache 110, and tracking interface 112, all intercommunicating via an internal network 114. System 100 communicates with remote components including one or more vendors 116(1-n), one or more subscribers 118(1-p), and one or more public databases 120(1-q), all via an internetwork 122 (e.g., the Internet). A firewall 124 provides a measure of security for internal network 114 against threats via internetwork 122.

Servers 104 host services for subscribers 118 and/or other authorized users that facilitate the tracking and/or monitoring of the location of tracking devices 102, including the geofence features described herein. Subscriber profile database 106 stores information associated with particular subscribers 118 and/or other users of system 100. Vendor information database 108 stores information associated with vendors 116 that provide goods and or services that can be made available to subscribers 118 and/or other users of system 100 based on information from subscriber profile database 106 and/or location data received from tracking devices 102. Public database cache 110 provides temporary storage for data retrieved from public databases 120. Tracking interface 112 transmits (via wireless communication) data and commands to tracking devices 102 and receives data (e.g., location data, sensor readings, distress signal, etc.) from tracking devices 102. Vendors 116 offer goods and services that may be offered to subscribers and other users of system 100 as described above. In addition, information associated with vendors (e.g., type of business) can be used to help define geofences used to monitor tracking devices 102. Similarly, public databases 120 provide information (e.g., sex offender registries, etc.) that can be used as criteria for defining geofences.

Subscribers 118 are the primary users of system 100 and interact with servers 104 to define tracking criteria and to obtain information and alerts regarding the tracking of associated tracking devices 102. In this example, the primary users are referred to as subscribers, because it is expected that users will be willing to pay for the right to use system 100. However, it should be understood that system 100 is not limited to a subscription type business model. For example, access to system 100 could be provided to users on a free basis, relying on some other business model to raise revenue.

FIG. 1A shows an example data structure for use in subscriber profile dB 106. In this example, the data is arranged in a relational database, which includes a Users table 150, a Tracking Devices table 152, a GeoFences table 154, and a GeoUsers table 156. Users table 150 stores data associated with authorized users of system 100.

The records of Users table 150 include a UserID field 160, a Name field 162, a ContactInfo field 164, and an OtherInfo field 166. UserID field 160 is the key field of table 150 and includes a unique identifier for each user of system 100. Name field 162 includes data indicative of the name of the associated user. ContactInfo field 164 includes information (or the location of information) used to contact the associated user, for example in the case of a geofence breach. OtherInfo field 166 can include any additional information considered necessary or desirable by the system designer, for example to enable other functionality not specifically disclosed herein.

The records of Tracking Devices table 152 include a DeviceID field 170, a ConData field 172, an OpData field 174, and an OtherInfo field 176. DeviceID field 170 is the key field of table 152 and includes a unique identifier for each device tracked by system 100. ConData filed 172 includes information necessary to contact the associated device. OpData field 174 includes data regarding the operational capabilities (e.g., type of device, application programs running, etc.) of the associated device. OtherInfo field 176 can include any additional information considered necessary or desirable by the system designer, for example to enable other functionality not specifically disclosed herein.

The records of GeoFences table 154 include a GeoFenceID field 180, a GeoDef 182, OtherInfo field 184, and Private field 186. GeoFenceID field 180 is the key field of table 154 and includes a unique identifier for each geofence record stored therein. GeoDef field 182 includes a definition and/or a location of the definition (e.g., geographical boundaries, max speed, other device locations, etc.) of the associated geofence. OtherInfo field 184 can include any additional information considered necessary or desirable by the system designer, for example to enable other functionality not specifically disclosed herein. Private field 186 includes data indicative of whether the associated geofence record/definition is made available to all users, or whether the associated geofence is available to and/or was created by a particular user or particular group of users (e.g., subscribers to a geofence creation service).

GeoUsers table 156 associates a particular user, a particular device, and a particular geofence. The records of GeoUsers table 156 include a UserID field 190, a DeviceID field 192, a GeoFenceID field 194, and an Enabled? field 196. UserID field 190, DeviceID field 192, and GeoFenceID field 194 include the same type data as the related fields of the same names of tables 150, 152, and 154, respectively. Thus, the records of GeoUsers table 156 associate a particular geofence definition with a particular user and a particular tracking device. Enabled? field 196 indicates whether the associated geofence has been selectively enabled or disabled by the associated user. This provides an advantage, because it is easier to selectively enable/disable an associated geofence than it is to associate/dissociate the geofence with/from a particular user and a particular tracking device. In addition, the records of table 156 can be easily searched in order to present a user with a list of all geofences associated with the user, whether enabled or not.

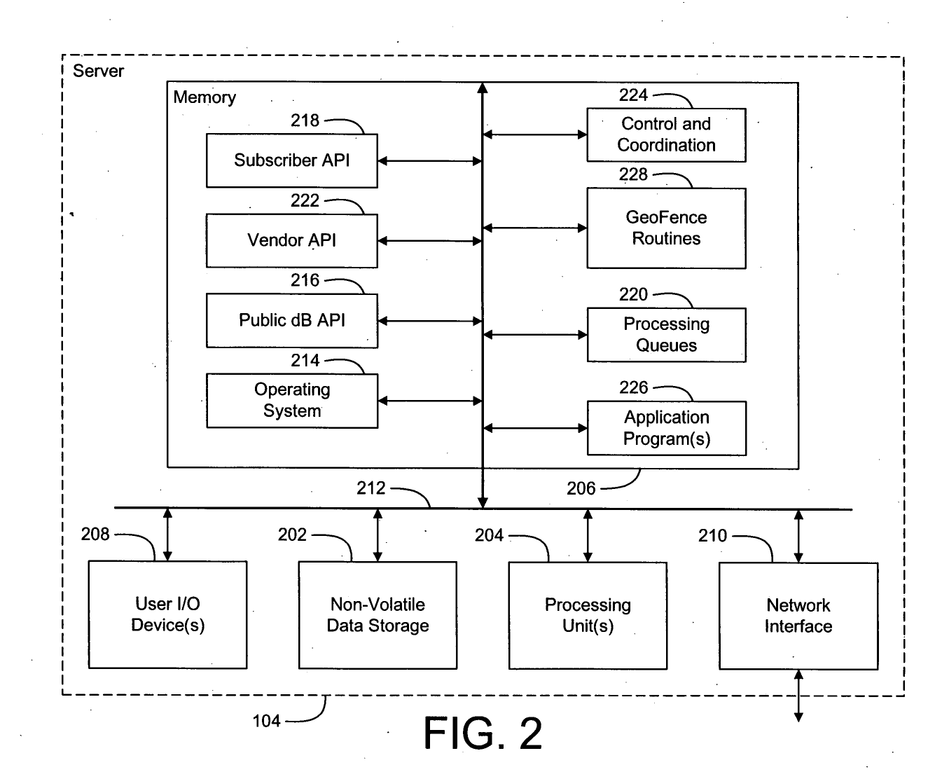

FIG. 2 is a block diagram of a server 102 of tracking system 100. Server 102 includes non-volatile data storage 202, one or more processing units 204, memory 206, user I/O devices 208, and a network interface 210. Nonvolatile data storage 202 stores data and code that is retained even when server 104 is powered down. Memory 206 stores data and code that when processed by processing unit(s) 204 imparts functionality to server 104. User input/output devices 208 (e.g., keyboard, mouse, monitor, etc.) provide a means of interaction between server 104 and a local human user. Network interface 210 provides a communication link to other components on internal network 114 and internetwork 122.

For the sake of clear explanation data and code are shown in memory 206 as functional blocks. It should be understood, however, that the various functions of server 104 need not be run in any particular location of memory 206 and may grouped in any useful manner. For example, the several application program interfaces (APIs) shown could be grouped into a single API.

Memory 206 includes an operating system 214, public database API 216, subscriber API 218, processing queues 220, vendor API 222, control and coordination routines 224, application programs 226, and geofence routines 228. Operating system 214 provides low level control of server 104 and provides a platform on top of which the other modules can operate. Application programs 226 are tracking service programs that receive and process location and/or sensor data from tracking devices 102, process the received data, communicate with subscribers 118, read and/or update subscriber profile database 106, search remote data sources, and so on. Public database API 216, vendor API 222, and subscriber API 218 provide a means of communication between application programs 226 and public databases 120, vendors 116, and subscribers 118, respectively. Control and coordination module 224 provides overall control and coordination of the tracking services provided by server 104. Processing queues 220 provide temporary storage for tracking data that is being processed.

Geofence routines 228 facilitate the definition and monitoring of geofences. For example, geofence routines 228 can define a geofence based on input received from a subscriber via subscriber API 218 (or subscriber profiles 106) and associate the geofence with a particular one (or several) of tracking devices 102. Optionally, geofence routines 228 can create/modify a geofence based on information received from one or more of subscriber profile database 106, vendor information database 108, public database cache 110, public databases 120, vendors 116, and location data from tracking devices 102.

Geofences can be stored and/or monitored in a variety of locations including, but not limited to, server 104, subscriber database 106, and/or tracking devices 102. For example, after defining the geofence, geofence routines 228 can transfer the geofence definition(s) to the associated tracking device(s) 102. Then, the associated tracking device(s) 102 monitor the location of the associated tracking device(s) 102 and notify server 104 in the event of a geofence breach. Optionally, the geofence definition is stored by server 104 and geofence routines 228 use location data received from tracking device 102 to monitor for geofence breaches. It is presently thought that transmitting the geofence definitions to the tracking device so that the tracking device can monitor the geofence for breach provides an advantage, because the required number of communications between the tracking device and the server is significantly reduced, thereby saving power and time-based communication charges. However, there are some circumstances where monitoring the geofences on the server is equally acceptable or preferred. These circumstances include, but are not limited to, the monitoring of dynamic geofences that change frequently; the monitoring of geofences that require location data from other tracking devices; and monitoring tracking devices that have a flat rate charge communication plan. In yet another embodiment, the geofences are monitored by tracking device 102, but the geofence definitions are updated by server 104 and the updated definitions are periodically communicated to tracking device 102, thereby updating the geofence definitions on tracking device 102. Periodically updating the geofence definitions provides an advantage in a number of situations including, but not limited to, where there is a significant change in the position of the tracking device and/or changes in the database(s) or other underlying information upon which the geofence definitions are based. In yet another embodiment, the tracking data is transmitted to subscriber system 118, and the geofences are monitored on subscriber system 118.

As indicated previously herein, notification is transmitted to the user in the event of a geofence breach. The notification can be sent via any useful form including, but not limited to, SMS, e-mail, telephone, an so on. The particular transport medium will depend on the notification type. For example, e-mail notification can be sent via internetwork 122. As another example, a telephone message can be sent over internetwork 122 (voice over IP) or over a separate telephone (wired or wireless) network (not shown).

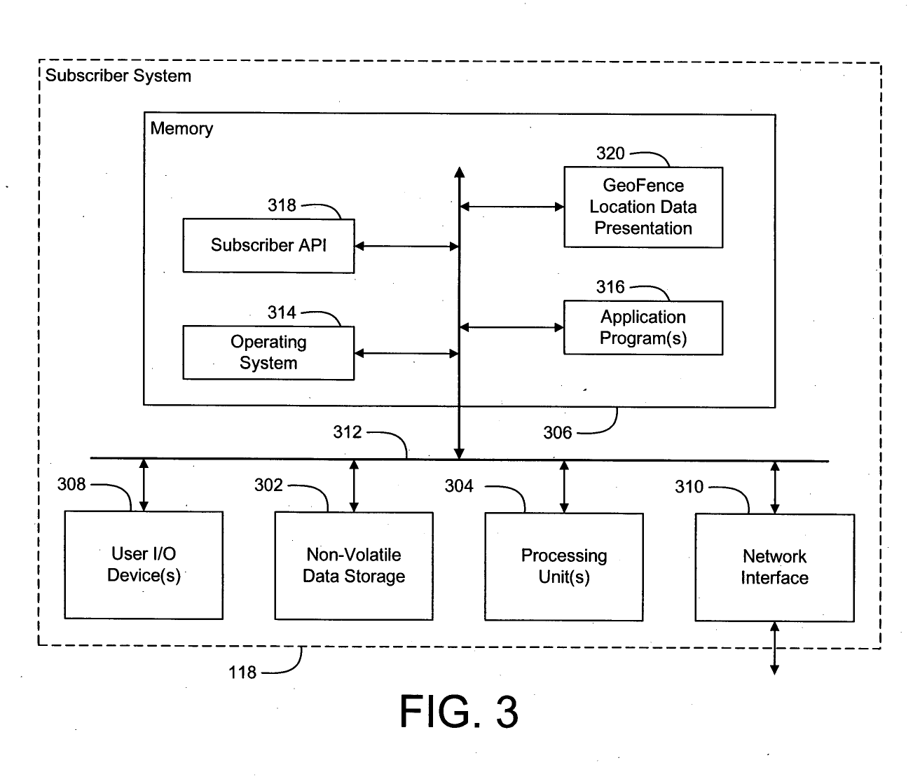

FIG. 3 is a block diagram of a subscriber system 118 of tracking system 100. Subscriber system 118 includes non-volatile data storage 302, one or more processing units 304, memory 306, user I/O devices 308, and a network interface 310, all intercommunicating via a bus 312. Memory 306 includes operating system 314, application programs 316, subscriber API 318, and geofence location data presentation module 320. Application programs 316 provide various tracking based services (e.g., set up tracking account, associate particular tracking devices 102 with user account, receive and/or display real time and/or historical location information associated with particular tracking devices 102, and so on). Subscriber API 318 (in conjunction with subscriber API 218 of server 104 shown in FIG. 2) facilitates communication between application programs 316 of subscriber system 118 and application programs 226 of server 104 (FIG. 2). Geofence location data presentation routines provide a graphical user interface (GUI) for receiving input from a user for use in defining one or more geofences and/or for displaying definitions and status of defined geofences.

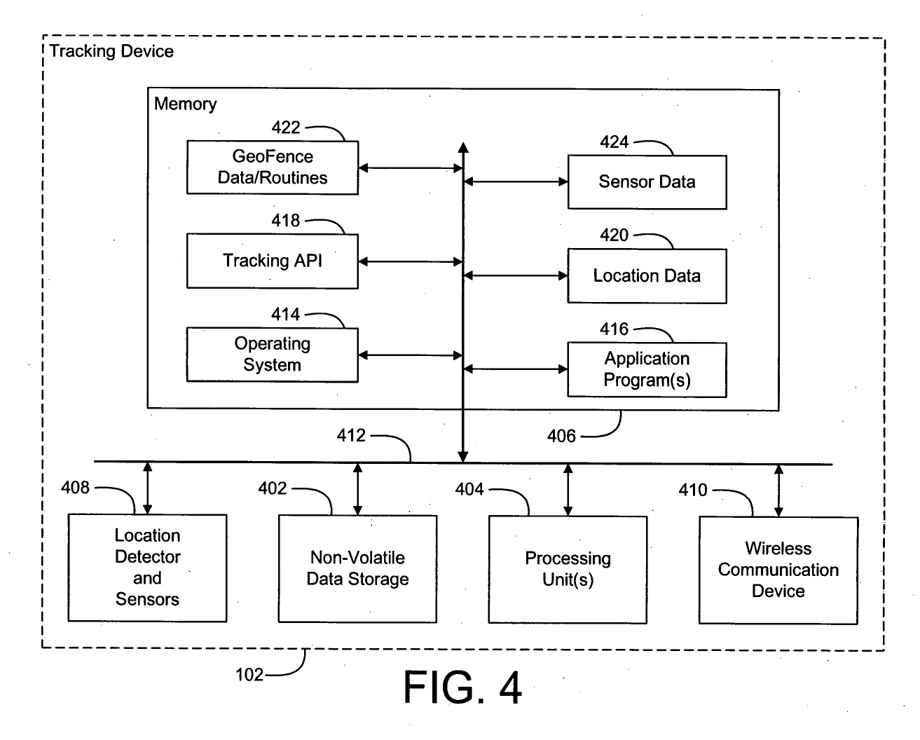

FIG. 4 is a block diagram of a tracking device 102 of tracking system 100. Tracking device server 102 includes non-volatile data storage 402, one or more processing unit(s) 404, memory 406, location detector (e.g., GPS receiver) 408 with optional sensors (e.g., temperature sensor, motion sensor, etc.), and a wireless communication device 410, all intercommunicating via a bus 412. Memory 406 includes an operating system 414, application programs 416, a tracking API 418, location data 420, geofence routines 422, and sensor data 424. Application programs 416 facilitate the processing of location data 420 and/or sensor data 424, provide alerts and/or updates to server 104 (FIG. 1), facilitate updates to existing routines or the addition of new routines, and provide any other specified functionality for tracking device 102. For example, application programs 416 can be updated or replaced by server 104 via tracking interface 112. Tracking API facilitates communication between application programs 416 and application programs 226 of server 104, for example, to communicate location data from tracking device 102 to server 104. Sensor data 424 and location data 420 can be accessed by application programs 416 as needed. Data indicative of the velocity of tracking device 102 can be characterized as either sensor data or location data. Geofence data/routines 422 monitor location data 420 and sensor data 424 in view of defined geofences to determine any breaches of the defined geofences. Additionally, geofence routines 422 facilitate the update of current geofence definitions.

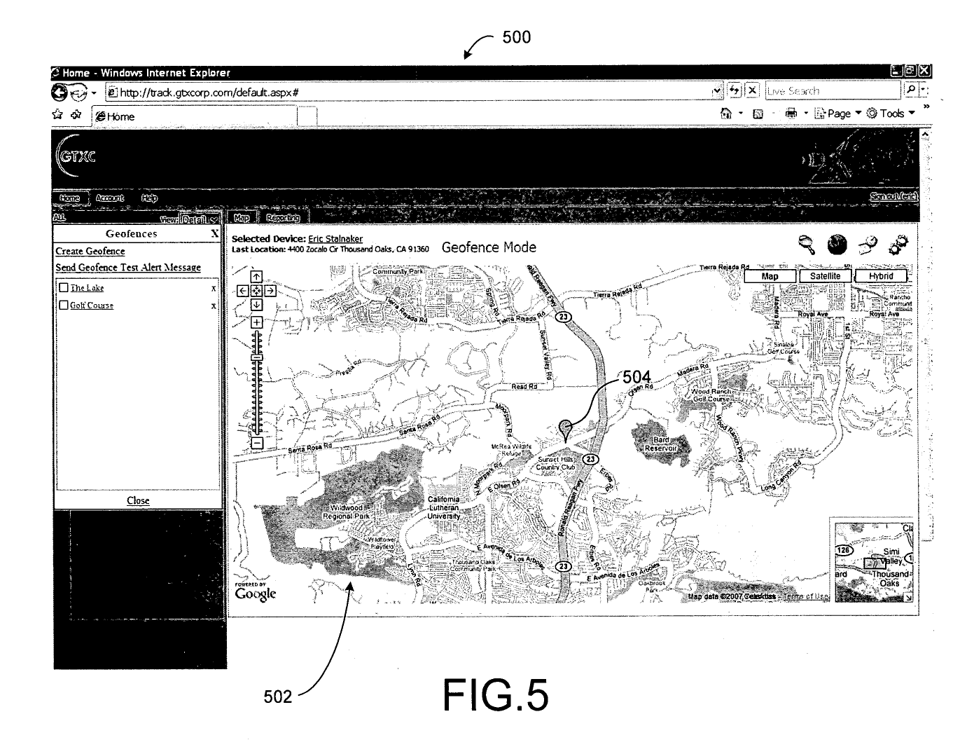

FIG. 5 is a screen shot of a main screen 500 of a GUI of subscriber system 118. Main screen 500 includes a map section 502 and a marker 504 indicative of the position of tracking device 102. It should be noted that map section 502 will vary as necessary depending on the geographical location of tracking device 102, and marker 504 moves on map section 502 based on changes in the position of tracking device 102 (carried by an associated tracked subject).

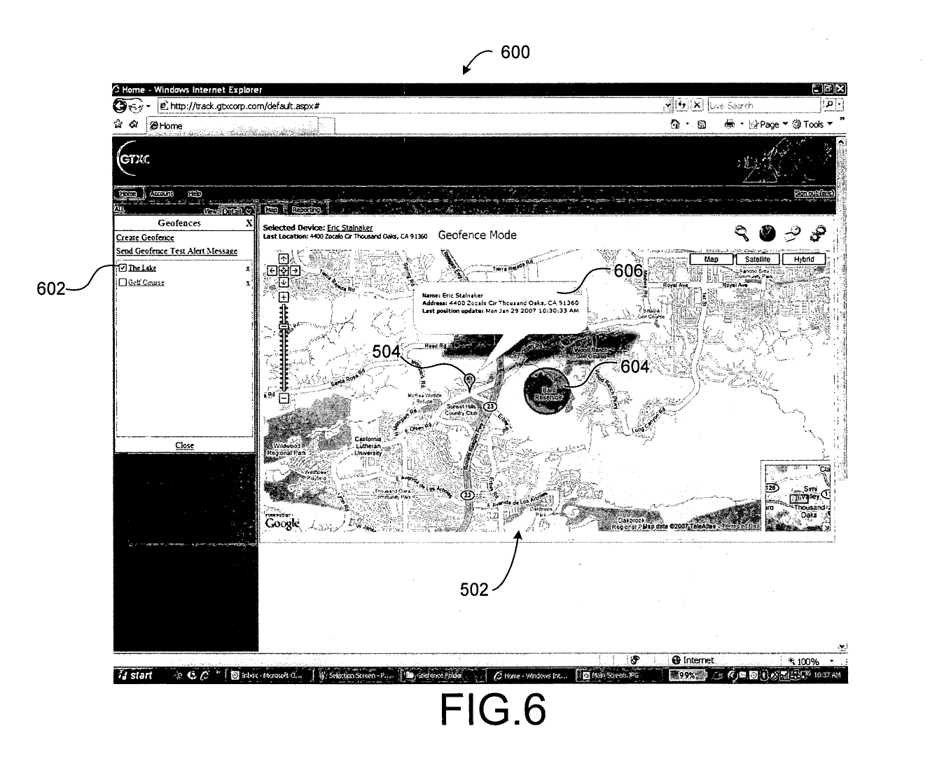

FIG. 6 is a screen shot 600 of a red zone selection 602 and indicated red zone area 604 upon map section 502. In addition, subject information 606 is further displayed to provide a subscriber with information about the tracked subject.

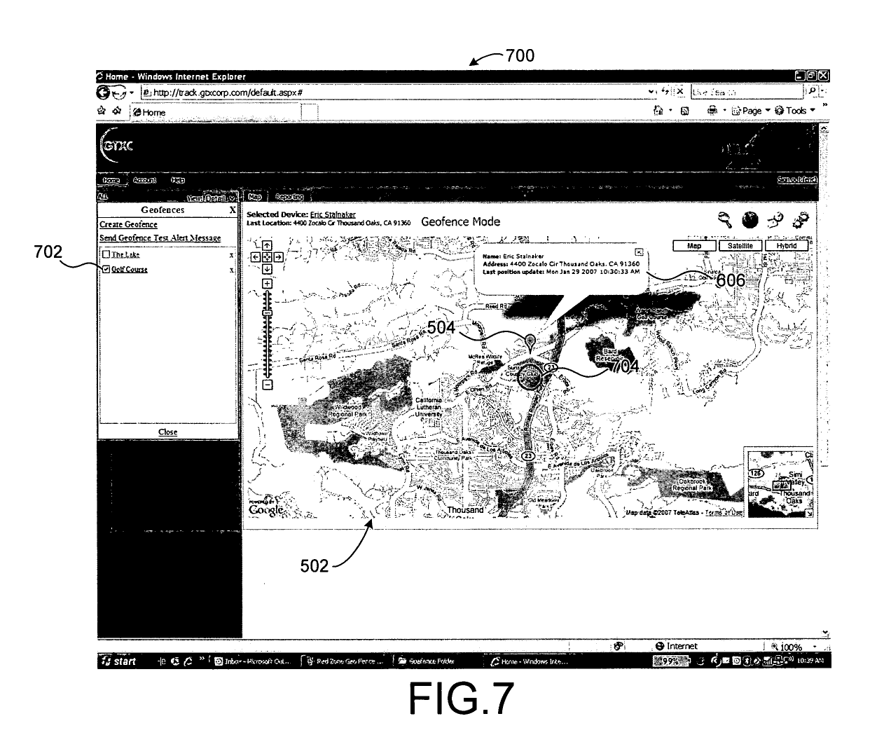

FIG. 7 is a screen shot 700 of a green zone selection 702 and indicated green zone area 704 upon a map section 502. In addition, subject information 606 is further displayed to provide a subscriber with information about the tracked subject.

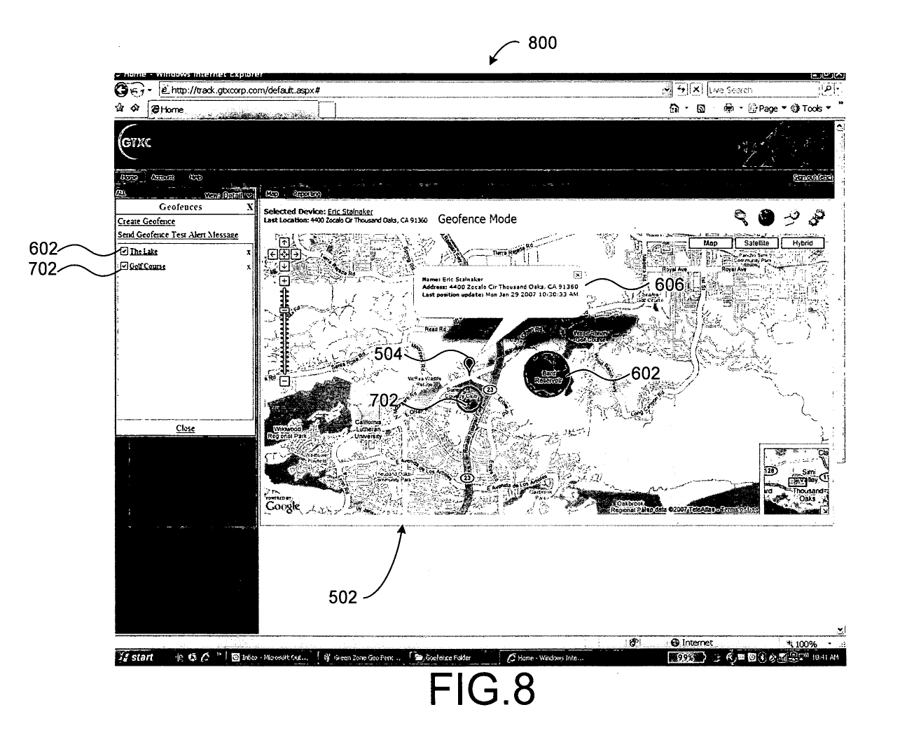

FIG. 8 is a screen shot 800 of both a red zone selection 602 and a green zone selection 702 and the indicated red zone area 602 and green zone area 702 on map section 502. As was discussed in previous figures, the marker 504 is indicative of a subject's position within map section 502, and subject information 606 is displayed to provide a subscriber with information about a tracked subject.

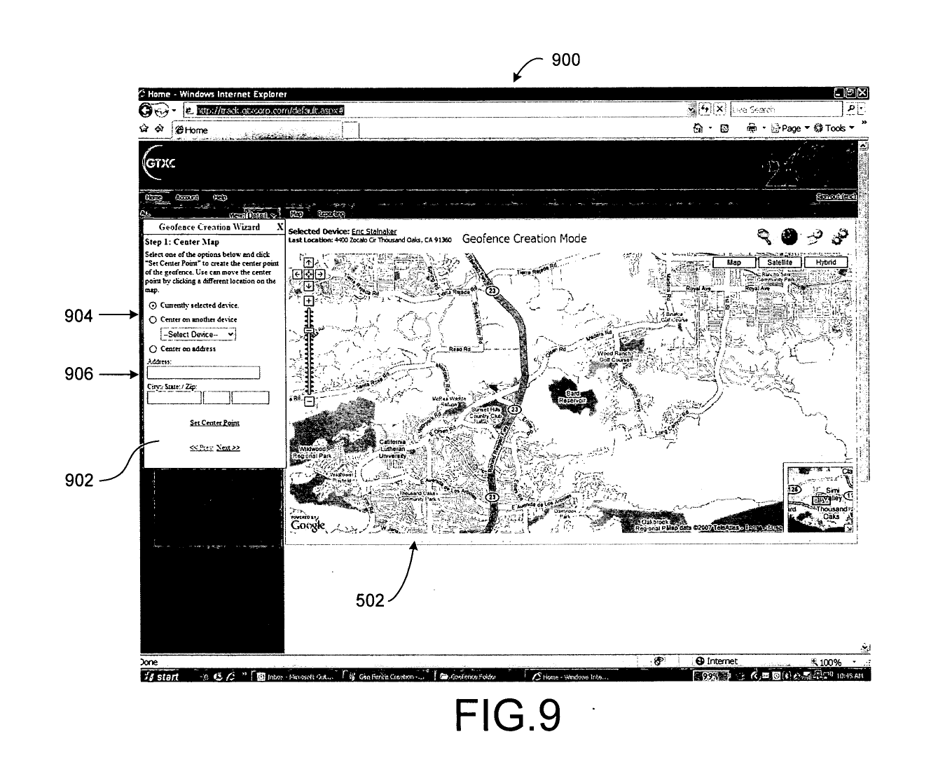

FIG. 9 is a screen shot 900 of a geofence creation screen 902. This screen is used to center the map in preparation for the creation of a geofence. Geofence creation screen 902 includes multiple criteria input means such as device selection buttons 904, address information inputs 906, and so on.

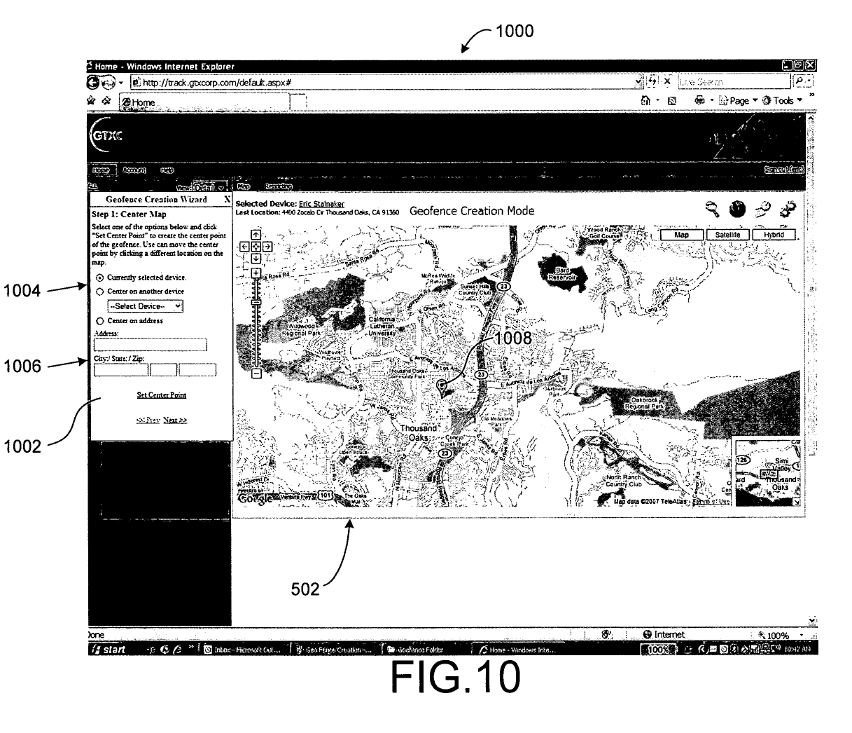

FIG. 10 is a screen shot 1000 of a center point creation screen 1002. Center point creation screen 1002 shows a marker 1008 indicative a center point for the geofence to be created. Marker 1008 is entered, for example, by the user clicking on map 502 with a pointing device.

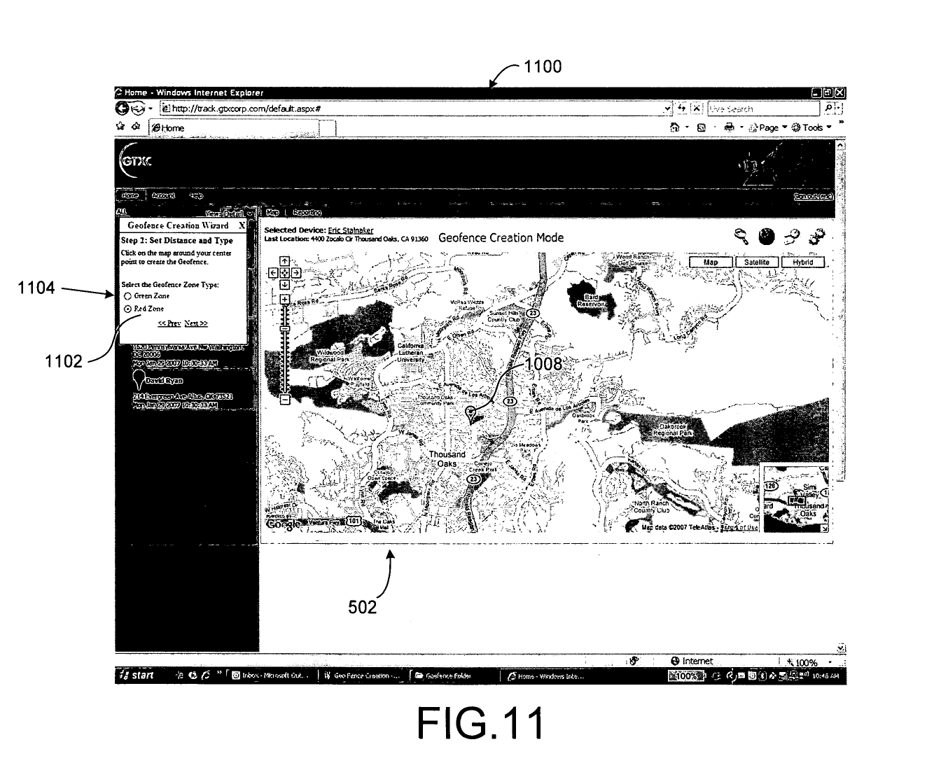

FIG. 11 is a screen shot 1100 of a zone creation screen 1102 that facilitates entry of the size and type of the geofence being created. Zone creation screen 1102 includes type selection buttons 1104 for selecting the desired zone type to be created. The size (e.g. radius) of the geofence is set by the user selecting a point a desired distance from centering marker 1008 on map section 502. To summarize, a zone (i.e., a geofence definition) can be created by placing a centering marker 1008 on map section 502, selecting a point on the map section 502 around the centering marker 1008 to define the area of the zone, and then selecting a zone type (inclusive or exclusive), which can be used to generate an alarm if the subject breaches the zone.

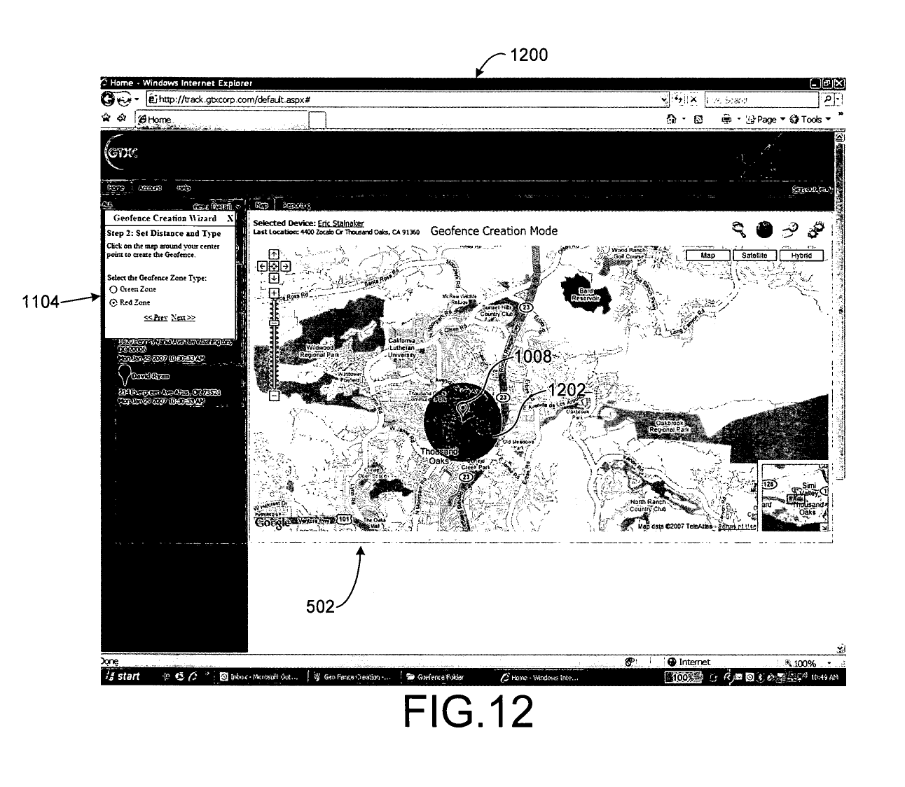

FIG. 12 is a screen shot 1200 of the zone creation screen following the creation of a zone as illustrated in FIG. 11. As can be seen, centering marker 1008 has been set, zone type selection buttons 1104 have been set for a red zone, and a zone perimeter 1202 has been set around centering marker 1008 on map section 502. The area within the created zone is shaded red (not visible in black-and-white drawings) to indicate the type of zone.

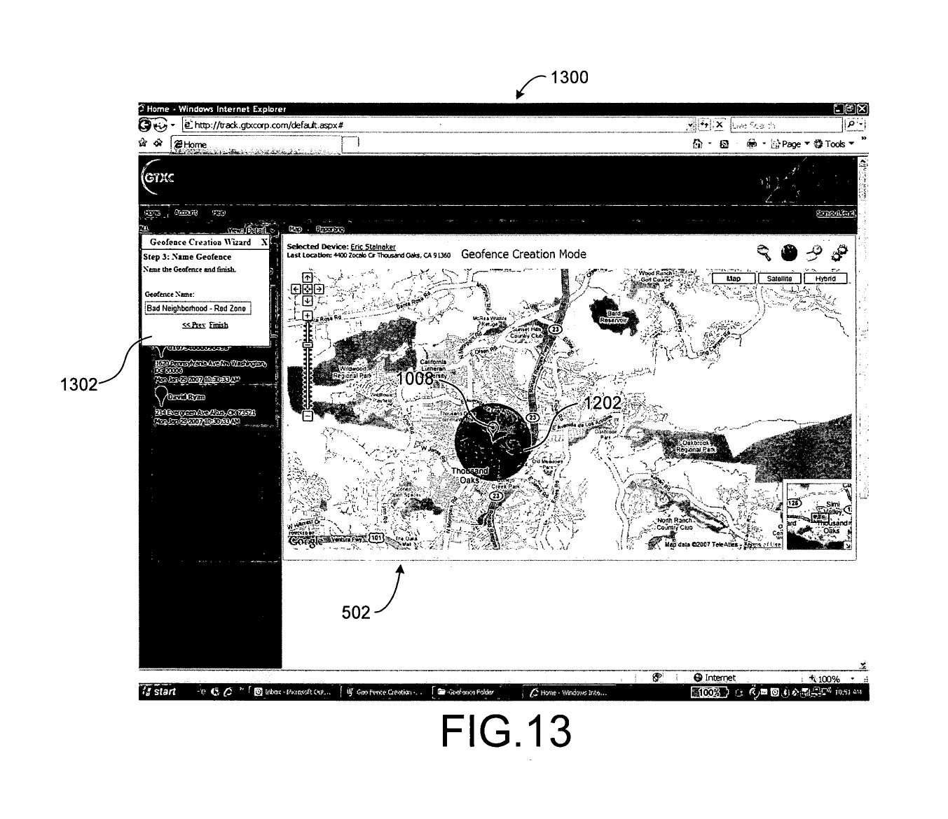

FIG. 13 is a screen shot 1300 of a zone naming section 1302. Zone naming section 1302 allows a user to name the previously created zone. In this particular example, the red zone created in FIGS. 11 and 12 has been named “Bad Neighborhood” and given a perimeter 1202 about centering marker 1008 as previously discussed.

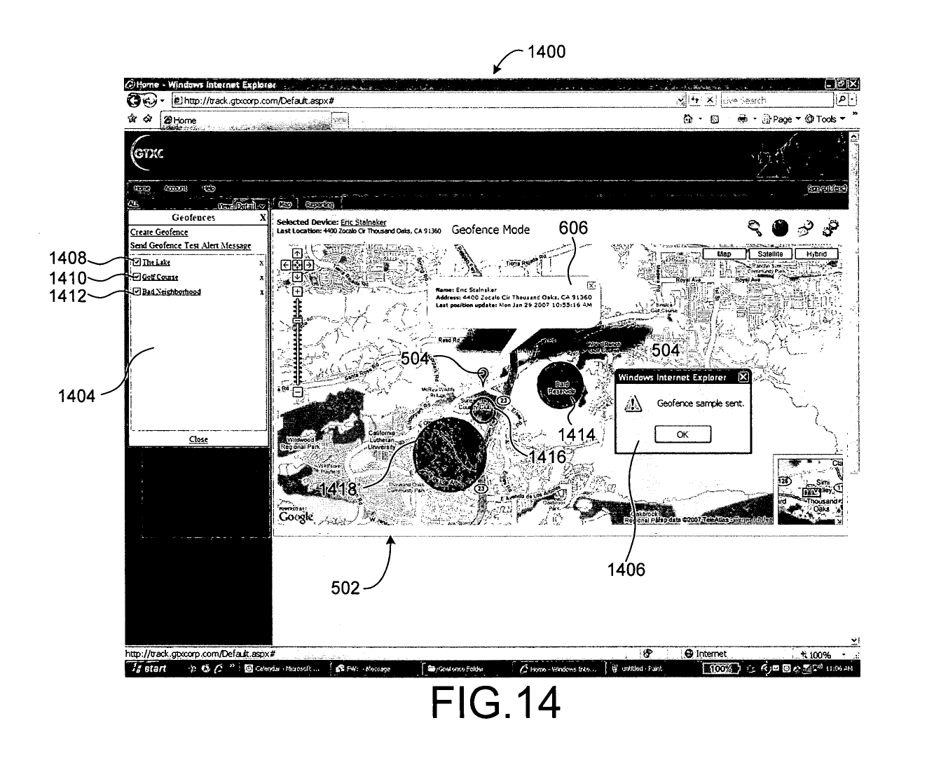

FIG. 14 is a screen shot of a zone creation acknowledgment screen 1400. Zone creation acknowledgment screen 1400 includes a geofence list 1404, test warning sent message 1406, names of individual geofences 1408, 1410, and 1412 and their corresponding zone perimeters 1414, 1416, and 1418, a marker 504 indicative of the position of the tracked subject, and subject information 606. Screen shot 1400 provides information associated with several geofences in one display. For example, the defined zones are shown with respect to a subject's location marker 504. Which geofences are activated is also shown.

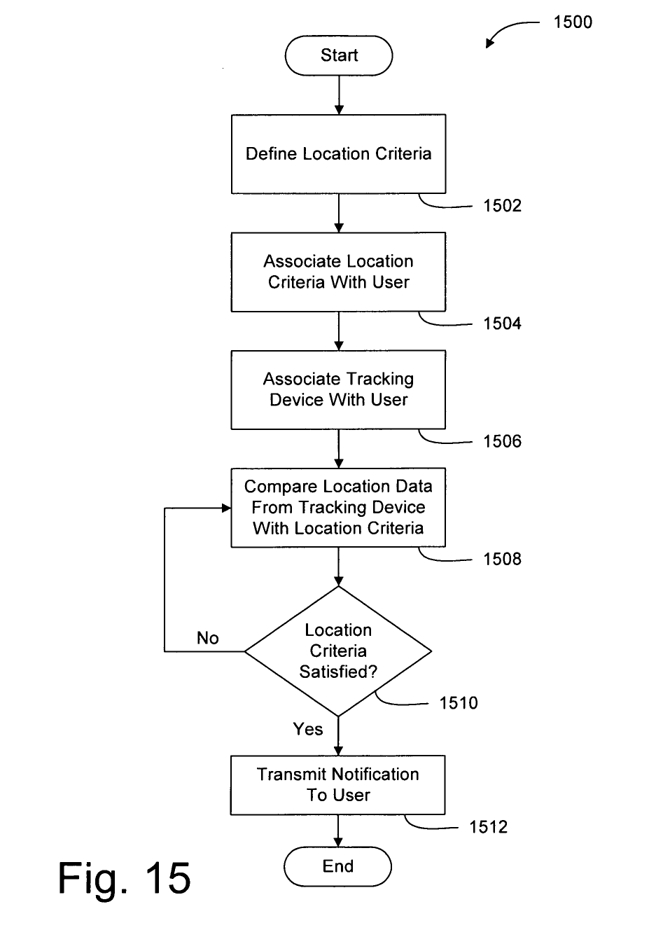

FIG. 15 is a flowchart summarizing an example method 1500 of monitoring the location of a tracking device. In a first step 1502, location criteria is defined (e.g., define a geofence). Then, in a second step 1504 the location criteria is associated with a user. Next, in a third step 1506, a tracking device is associated with the user. Then, in a fourth step 1508, location data from the tracking device is compared to the location criteria. Next, in a fifth step 1510, it is determined whether the location data satisfies the location criteria (e.g., a geofence breach). If the location data from the tracking device does satisfy the location criteria, then in a sixth step 1512, notification is transmitted to the user. Otherwise, method 1500 returns to fourth step 1508 where new location data from the tracking device is compared to the location criteria.

The description of particular example embodiments of the present invention is now complete. Many of the described features may be substituted, altered or omitted without departing from the scope of the invention. For example, alternate zone types, alert types, and so on, may be added to and/or substituted for those shown herein. As another example, geofences can be defined by a user placing line segments on an image of a map (e.g., along depicted streets) to define a closed polygonal area. These and other deviations from the particular embodiments shown will be apparent to those skilled in the art, particularly in view of the foregoing disclosure.

We claim:

1. A method for monitoring the location of a tracking device, said method including:
defining location criteria;
associating said location criteria with a user;
associating said tracking device with said user;
comparing location data generated by said tracking device to said location criteria; and
transmitting notification to said user if said location data satisfies said location criteria.

2. A method according to claim 1, wherein:
said location criteria defines an enclosed geographical area; and
said location data satisfies said location criteria if said location data indicates that said tracking device has entered said enclosed geographical area.

3. A method according to claim 1, wherein:
said location criteria defines an enclosed geographical area; and
said location data satisfies said location criteria if said location data indicates that said tracking device has departed from said enclosed geographical area.

4. A method according to claim 1, wherein said location criteria defines a plurality of enclosed geographical areas.

5. A method according to claim 4, wherein:
at least one of said geographical areas is defined as a safe zone such that notification to said user is transmitted if said location data indicates that said tracking device has transitioned from a position within said safe zone to a position outside of said safe zone; and
at least one of said geographical areas is defined as an unsafe zone such that notification to said user is transmitted if said location data indicates that said tracking device has transitioned from a position outside of said unsafe zone to a position inside of said unsafe zone.

6. A method according to claim 1, wherein said step of defining said location criteria includes receiving input from said user indicative of a geographical area.

7. A method according to claim 6, wherein receiving input from said user receiving an indication of a center point of said geographical area.

8. A method according to claim 7, wherein:
receiving input from said user further includes receiving an indication of a second point; and
said geographical area is defined as a circle using said center point and said second point.

9. A method according to claim 6, wherein:
receiving input from said user includes receiving an indication of a plurality of points; and
said geographical area is defined as a polygon using said plurality of points to define vertices of said polygon.

10. A method according to claim 6, wherein receiving input from said user indicative of a geographical area includes:
presenting a map to said user;
receiving an indication of the user's selection of points on said map.

11. A method according to claim 1, wherein said step of defining said location criteria includes:
defining a plurality of geographical areas;
presenting indicators associated with each of said defined geographical areas to said user;
receiving input from said user indicating the selection at least one of said geographical areas; and
defining said location criteria to include any of said geographical areas selected by said user.

12. A method according to claim 1, wherein said step of defining said location criteria includes:
retrieving data from a remote data source; and
using said retrieved data to define said location criteria.

13. A method according to claim 12, wherein said remote data source is a public database.

14. A method according to claim 12, wherein said remote data source includes data associated with sex offenders.

15. A method according to claim 12, wherein said remote data source includes data indicative of a business type.

16. A method according to claim 12, wherein:
said retrieved data is used to define new geographical zones; and
said retrieved data is used to update previously defined geographical zones.

17. A method according to claim 1, wherein:
comparing location data generated by said tracking device to said location criteria includes determining a speed of said tracking device; and
comparing location data generated by said tracking device to said location criteria includes comparing said speed of said tracking device to a predetermined speed.

18. A method according to claim 1, wherein transmitting notification to said user if said location data satisfies said location criteria includes transmitting notification to said user if said tracking device has not changed position for a predetermined time period.

19. A method according to claim 1, wherein said location criteria associated with said user includes a plurality of discrete conditions that can be individually enabled or disabled by said user.

20. A method according to claim 1, wherein said step of comparing location data generated by said tracking device to said location criteria includes:
transmitting said location criteria to said tracking device; and
receiving notification from said tracking device if said location data satisfies said location criteria.

21. A method according to claim 20, further comprising periodically transmitting updated location criteria to said tracking device.

22. A method according to claim 1, wherein said step of comparing location data generated by said tracking device to said tracking criteria is performed by a server in wireless communication with said tracking device.

23. A method according to claim 1, further comprising transmitting tracking application programs to said tracking device to be run on said tracking device.

24. A method according to claim 1, further comprising:
defining sensor criteria;
receiving sensor data indicative of sensor readings from said tracking device;
comparing said sensor data to said sensor criteria; and
transmitting notification to said user if said sensor data satisfies said sensor criteria.

25. A method according to claim 1, wherein said location criteria includes data indicative of the location of another tracking device.

26. A method according to claim 1, wherein:
defining said location criteria includes determining the present locations of a group of other tracking devices selected by the user; and
comparing said location data generated by said tracking device to said location criteria includes determining whether any of said other tracking devices are within a predetermined distance from said tracking device.

27. A computer-readable storage medium having code embodied therein for causing a computer to perform the method of claim 1.

28. A system for monitoring a tracking device, said system comprising:
a tracking device interface for communicating with said tracking device;
a network interface for communicating with a user;
a processing unit for processing data and code; and
memory for storing said data and said code, said data and said code together including data associating said tracking device with said user,
location criteria associated with said user, and
a monitoring routine operative to transmit notification to said user if location data generated by said tracking device satisfies said location criteria.

29. A system according to claim 28, wherein:
said location criteria defines a geographical area; and
said location data satisfies said location criteria if said location data indicates that said tracking device has entered said geographical area.

30. A system according to claim 28, wherein:
said location criteria defines a geographical area; and
said location data satisfies said location criteria if said location data indicates that said tracking device has departed from said geographical area.

31. A system according to claim 28, wherein said location criteria defines a plurality of discrete geographical areas.

32. A system according to claim 31, wherein:
at least one of said geographical areas is defined as a safe zone, and said monitoring routine is operative to transmit notification to said user if said location data indicates that said tracking device has moved outside said safe zone; and
at least one of said geographical areas is defined as an unsafe zone, and said monitoring routine is operative to transmit notification to said user if said location data indicates that said tracking device has moved into said unsafe zone.

33. A system according to claim 32, wherein said monitoring routine is operative to define said location criteria based at least in part on input from said user.

34. A system according to claim 33, wherein said monitoring routine is operative to define said location criteria based at least in part on said user's selection of points on an image of a map.

35. A system according to claim 28, wherein:
said data includes a plurality of predefined geographical areas; and
said monitoring routine is operative to present said plurality of predefined geographical areas to said user, to receive input from said user indicating the selection of at least one of said predefined geographical areas, and to define said location criteria associated with said user to include said geographical areas selected by said user.

36. A system according to claim 28, further comprising:
a remote data source interface operative to retrieve data from a remote data source; and
wherein said data retrieved from said remote data source is used to define said location criteria.

37. A system according to claim 36, wherein said remote data source interface is adapted to communicate with a public database.

38. A system according to claim 36, wherein said remote data source interface is adapted to receive data associated with sex offenders.

39. A system according to claim 36, wherein said remote data source is adapted to receive data indicative a business type.

40. A system according to claim 36, wherein:
said retrieved data is used to define new geographical zones; and
said retrieved data is used to update previously defined geographical zones.

41. A system according to claim 28, wherein:
a speed of said tracking device is determined from said location data;
said location criteria includes a predetermined speed limit; and
said monitoring routine is operative to transmit notification to said user if said speed of said tracking device meets or exceeds said predetermined speed limit.

42. A system according to claim 28, wherein said monitoring routine is operative to transmit notification to said user if said location data indicates that said tracking device has not changed position for a predetermined time period.

43. A system according to claim 28, wherein said location criteria associated with said user includes a plurality of discrete conditions that can be individually enabled or disabled by said user.

44. A system according to claim 28, wherein said tracking device interface is operative to:
transmit said location criteria to said tracking device; and
receive notification from said tracking device if said location data satisfies said location criteria.

45. A system according to claim 44, wherein said tracking device interface is operative to periodically transmit updated location criteria to said tracking device.

46. A system according to claim 28. wherein said monitoring routine is operative to compare said location data from said tracking device to said location criteria to determine whether said location data satisfies said location criteria.

47. A system according to claim 28, wherein said racking device interface is operative to transmit tracking application programs to said tracking device.

48. A system according to claim 28, wherein:
said data and said code together further include sensor criteria;
said tracking device interface is further operative to receive sensor data from said tracking device; and
said monitoring routine is further operative to transmit notification to said user if said sensor data satisfies said sensor criteria.

49. A system according to claim 28, wherein said location criteria includes data indicative of the location of another tracking device.

50. A system according to claim 28, wherein:
said location criteria includes data indicative of the present location of a group of other tracking devices selected by said user; and
said monitoring routine is operative to transmit notification to said user if any of said other tracking devices are within a predetermined distance from said tracking device.

51. In a computer system having a graphical user interface including a display and a selection device, a method for receiving input from a user, said method comprising:
presenting a set of indicators on said display, said indicators each representing a previously defined discrete location condition;
receiving input from said selection device indicating the selection of at least one of said discrete location conditions; and
associating at least one tracking device with said selected discrete location conditions.

52. A method according to claim 51, further comprising:
presenting a second set of indicators on said display, said second set of indicators representing said discrete location conditions selected by said user;
receiving input from said selection device indicating the selection of at least one indicator from said second set of indicators; and
receiving input indicative of an enablement or disablement instruction; and
enabling or disabling said discrete location conditions associated with said indicators selected from said second set of indicators.

53. A computer-readable storage medium having a data structure embodied therein, said data structure comprising:
a first field including data indicative of a user;
a second field including data indicative of a tracking device associated with said user; and
a third field including data indicative of a geographical area selected by said user to be used in conjunction with monitoring the location of said tracking device.
